(19) United States
(12) Patent Application Publication
(10) Pub. No.: US 2013/0151705 A1
(43) Pub. Date: Jun. 13, 2013

(54) SYSTEM FOR PROVISIONING DIVERSE TYPES OF RESOURCES THROUGH A UNIFIED INTERFACE

(71) Applicants: Sanjay Menon, Sunnyvale, CA (US); Krishnendu Chakraborty, Fremont, CA (US); Ajit Shrivastav, Sunnyvale, CA (US)

(72) Inventors: Sanjay Menon, Sunnyvale, CA (US); Krishnendu Chakraborty, Fremont, CA (US); Ajit Shrivastav, Sunnyvale, CA (US)

(73) Assignee: APPLE INC., Cupertino, CA (US)

(21) Appl. No.: 13/314,109

(22) Filed: Dec. 7, 2011

(51) Int. Cl. G06F 15/16

(52) U.S. Cl. 709/226

(57) ABSTRACT

By using a unified generic resource provisioning system, all of an organization's resources may be provisioned through a single user interface system, a single cohesive data model, and a single consistent model of access. The system described herein provisions an organization's resources to both new and existing employees in response to different employee events. For example, in response to a single event that indicates that an employee has been hired by the company, he is automatically given access to a phone, a badge, a virtual machine, and SSL certificates that he can use during his employment with the company. Much later, when the same employee terminates his employment with the company, that employee's access to all of these resources is revoked in response to another single event, such as an event originating from a human resources department, indicating that employee's last date of hire with the company.

### CROSS-REFERENCE TO RELATED APPLICATIONS

The present application is related to U.S. patent application Ser. No. 13/287,973, titled “NOTIFICATION AND REMINDER GENERATION, DISTRIBUTION, AND STORAGE SYSTEM,” filed on Nov. 2, 2011, the entire contents of which are incorporated by reference herein.

### FIELD OF THE INVENTION

The present invention relates to a computerized system for provisioning company resources to users.

### BACKGROUND

“Resource” is a commonly used term in any organization. To some, it could mean a cube (as discussed herein, a “cube” is a physical space that is dedicated to a particular person's work functions), telephone, or a security badge. To others, it could mean a virtual machine, Secure Sockets Layer (SSL) certificate, or something different. In any organization, resources are associated with users on a daily basis. Users could be employees or customers who want access to a specific resource. For example, a new employee who joins a company might need to be given access to his phone, badge, or cube. Similarly, an employee working on a mission critical project might need access to a virtual machine for the next six months. An application user might need access to a SSL certificate for securing the application on his device (e.g., computer or phone). Hence, a resource can be viewed as a somewhat abstract concept. The set of operations that may be performed relative to a particular resource may depend on the type of that particular resource.

A user may be associated with a resource. A group of users may be given access to a resource. The act whereby an executing software element associates a resource with a user and provides the user with access to perform certain operations on the resource is defined as resource provisioning. If resource provisioning software provides a virtual machine to a particular user, then that resource provisioning software ideally should be able to control all operations that the user can perform on that virtual machine. Such operations for a normal user could include the ability to start, stop, or extend the lease on the virtual machine, for example, but not the ability to destroy the virtual machine.

Some specialized kinds of resource provisioning software may be capable of provisioning a single specific type of resource. For example, one specialized kind of resource provisioning software might manage virtual machines in a cloud, while another, separate specialized kind of resource provisioning software might manage certificates for customers. However, a significant drawback of all of these specialized kinds of resource provisioning systems is that none of them define a generic data model that enables the provisioning of various highly different kinds of resources, which might range from access to a phone, on one hand, to access to a virtual machine, on the other hand. The gamut of types of resources in an organization is usually considered to be too large to cover for any single data model to encompass. Multiple drawbacks may be found in existing specialized resource provisioning systems.

First, existing specialized resource provisioning system tend to cater only to a single specific type of resource and a single specific type of user. These types are also fixed. The data models used by these specialized resource provisioning systems do not allow for the augmentation of the definition of the specific type of resource to include anything different. The consequence of each specialized provisioning system only being able to handle a single specific resource type is that a company ends up using a separate and non-integrated specialized resource provisioning systems for each different kind of resource that the company has. These multiple systems typically do not communicate with each other.

Second, existing specialized resource provisioning systems tend to have user interfaces that are also specific to the single resource type that those systems provision. It is unfortunate that the developers of each specialized resource provisioning system have had to develop and maintain independent user interfaces, because such divided efforts often lead to a duplication of some work and a lack of re-use of some user interface components which otherwise could potentially be shared.

Third, existing specialized resource provisioning systems each have a separate, different data model that depends on the specific type of resource that is managed by each system. Due to this diversity in data models, when an organization uses multiple different specialized resource provisioning systems, the organization's data becomes fragmented.

Fourth, specialized resource provisioning systems are often maintained and upgraded by different business entities that might not have any association or communication with each other. Whole resource domains are re-engineered again and again. Life cycles of each resource are maintained separately.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

FIG. 1 is a block diagram that illustrates an example of a data model that defines various object types and the relationships between those object types, according to an embodiment of the invention.

FIG. 2 is a block diagram that illustrates example names and purposes of various columns in a resource table and a resource content table, according to an embodiment of the invention.

FIG. 3 is a flow diagram that illustrates a high-level example of a technique for provisioning a resource to a user via the unified generic resource provisioning system, according to an embodiment of the invention.

FIG. 4 is a block diagram that illustrates a more concrete representation of work flows using the data model illustrated in FIG. 1, according to an embodiment of the invention.

FIG. 5 is a block diagram that illustrates a computer system upon which an embodiment of the invention may be implemented.

FIG. 6 is a diagram that illustrates an example of a user interface through which a user can begin managing resources in his cloud by selecting a “manage my cloud” icon, according to an embodiment of the invention.

FIG. 7 is a diagram that illustrates an example of a user interface through which a user can request the provisioning of a new virtual machine resource by selecting a “new” icon in a “virtual machine” row, according to an embodiment of the invention.

FIG. 8 is a diagram that illustrates an example of a user interface through which a user can enter the name that will be assigned to the new virtual machine resource that he is requesting, according to an embodiment of the invention.

FIG. 9 is a diagram that illustrates an example of a user interface through which a user can select a project for which the new virtual machine resource will be provisioned, according to an embodiment of the invention.

FIG. 10 is a diagram that illustrates an example of a user interface through which a user can select a template that will be used to create the new virtual machine, according to an embodiment of the invention.

FIG. 11 is a diagram that illustrates an example of a user interface through which a user can select a service offering, including a quantity of cores and a memory size, for the new virtual machine, according to an embodiment of the invention.

FIG. 12 is a diagram that illustrates an example of a user interface through which a user can select a disk offering, including a disk size, for the new virtual machine, according to an embodiment of the invention.

FIG. 13 is a diagram that illustrates an example of a user interface through which a user can review his specified attributes for the new virtual machine before submitting his request for the new virtual machine to the resource service provider, according to an embodiment of the invention.

FIG. 14 is a diagram that illustrates an example of a user interface through which a user can request to view a current status of his submitted request for the new virtual machine by selecting a “view submitted request” option, according to an embodiment of the invention.

FIG. 15 is a diagram that illustrates an example of a user interface through which a user can view the pending-approval status icon of his submitted request for the new virtual machine, according to an embodiment of the invention.

FIG. 16 is a diagram that illustrates an example of a user interface through which a user can view the provisioning-completed status icon of his submitted request for the new virtual machine, according to an embodiment of the invention.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Resource Provisioning System Overview

A unified generic resource provisioning system that manages diverse types of resources is described herein. By using this unified generic resource provisioning system, all of an organization's resources may be provisioned through a single user interface system, a single cohesive data model, and a single consistent model of access. The system described herein provisions an organization's resources to both new and existing employees in response to different employee events. For example, in response to a single event that indicates that an employee has been hired by the company, he is automatically given access to a phone, a badge, a virtual machine, and SSL certificates that he can use during his employment with the company. Much later, when the same employee terminates his employment with the company, that employee's access to all of these resources is revoked in response to another single event, such as an event originating from a human resources department, indicating that employee's last date of hire with the company.

According to one embodiment of the invention, each data entity in the unified generic resource provisioning system is modeled as a resource, a request, or an approval. The resource represents thing to which a user wants access. The request represents the thing that indicates, to the back-end service provider who can grant access to that resource, the details of the access that the user wants (including the identity of the resource). The approval represents the thing that the back-end service provider uses to grant access to the requested resource, and to indicate to the user that access to the resource has been granted. Data pertaining to resources, requests, and approvals all may be stored persistently in a historical repository so that activities related to those entities may be retrieved later, potentially for reporting purposes.

In one embodiment of the invention, the unified generic resource provisioning system sits between users and various different back-end service providers that are capable of providing different resources to those users. Viewed in one way, the unified generic resource provisioning system acts as a one-stop broker between users and back-end service providers. As a broker, the unified generic resource provisioning system eliminates the need for users to communicate directly with multiple different back-end service providers in order to obtain access to the resources that those service providers provider. Furthermore, the unified generic resource provisioning system acts as a historian that maintains a permanent record of all interactions that transpire via the unified generic resource provisioning system.

### Detailed System Features

In one aspect, the unified generic resource provisioning system provides a generic data model, application programming interface, service, and user interface to provide users access to resources in an organization. The system provisions a wide range of resources, which may be as basic as a cube or as sophisticated as a virtual machine or a SSL certificate.

In one aspect, the data model and user interface flows are sufficiently generic that any resource can be added into the system with minimal service provider interfaces which communicate with a service that provides the actual resource.

In one aspect, the unified generic resource provisioning system maintains access of users to all of the organization's resources and provides audit logs for users who are no longer members of the organization. In response to a particular type of event, the system provides user access to multiple different types of resources. In response to another particular type of event, the system revokes user access to multiple different types of resources.

In one aspect, the unified generic resource provisioning system enables a service provider of a particular resource to call back and register relevant data regarding the state of a resource under circumstances in which that data might not previously have been available at the time that the particular resource was initially provisioned.

In one aspect, the unified generic resource provisioning system manages each resource as an abstract entity. This abstract entity can be used to represent any provisioned object. Each resource may have, associated therewith, leasing or licensing data that indicates an expiry date on which the resource is to be automatically revoked from the user to whom that resource is currently provisioned.

In one aspect, the unified generic resource provisioning system associates each resource with an owner, but also allows multiple different users to be associated with that resource. The system gives the owner the ability to provide, to each user associated with the resource, owner-specified privileges for that resource. In one aspect, the unified generic resource provisioning system supports the locking and unlocking of resources via soft and hard locks. Such locks help ensure the consistency of data by preventing more than one user at a time from modifying the resource's data.

In one aspect, the unified generic resource provisioning system provides multiple levels of authorization for each resource. For example, one user may be authorized to view a resource's associated data, while another user may be authorized to administer the resource's associated data.

In one aspect, the unified generic resource provisioning system uses a hierarchical data model. This hierarchical data model supports composite associations through resource content which can be associated with each resource.

In one aspect, the unified generic resource provisioning system supports “versioning” of each resource, by maintaining different versions of each resource for future reference and audit purposes. For example, in an organization, the definition of a particular virtual machine might change over a period of time. Under such circumstances, the unified generic resource provisioning system stores and retains a version of each definition of that particular virtual machine.

In one aspect, the unified generic resource provisioning system associates each resource with a resource template that defines the metadata for that resource. The metadata are sufficiently generic to support any type of resource. The metadata enable each resource to be associated with any number of data attributes. The data attributes for each resource may change over a period of time. The resource template may be a custom template defined by the user. The resource template may be a group of properties that define the template.

In one aspect, the unified generic resource provisioning system grants resource provisioning requests only if certain conditions, specified within system rules, are satisfied. For example, the unified generic resource provisioning system might receive, from a user, a request for a virtual machine to be provisioned for use with a specified project. In one embodiment of the invention, the unified generic resource provisioning system only forwards such a request to the service provider that allocates virtual machines to users if a quantity of virtual machines currently allocated to the specified project does not yet exceed a maximum quantity of virtual machines that the specified project is permitted to have. The rules for resource provisioning may be stored as constraints or expressions in the system. The rules may be stored by any rule engine that can execute the rules to ensure that the conditions are satisfied before requests are forwarded to service providers.

In one aspect, the unified generic resource provisioning system allow applications that interact with the system to define work flows that provide access to a resource. The unified generic resource provisioning system provides generic approval work flows that (a) provide users access to resources or (b) revoke access to resource from those users. The unified generic resource provisioning system also provides generic user interface flows that permit certain operations to be performed on the resources.

In one aspect, the unified generic resource provisioning system defines a request/response envelope. This envelope is sufficiently generic that it can be used in communications between the unified generic resource provisioning system and diverse other types of back-end systems with which the unified generic resource provisioning system interacts. The envelope enables diverse applications external to the unified generic resource provisioning system to integrate with the unified generic resource provisioning system.

In one aspect, the unified generic resource provisioning system supports a hierarchical access model for resources. For example, a specific project which maintains hundreds of virtual machines could be controlled by a group and only users in that group. Different ones of these virtual machines may be placed within different nodes of a hierarchical resource tree. Different nodes of the resource tree may be associated with different users or user groups. The system permits a user associated with a particular node of the resource tree to access resources within that particular node and all descendant nodes (but not any ancestor nodes) of that particular node within the resource tree. Similarly, a certificate could be nested with a chain of certificates. At each level of the resource tree, content may be associated with any resource at that level.

In one aspect, the unified generic resource provisioning system supports the automatic provisioning of resources such that users are not required to interact with any user interfaces in order to obtain access to those resources. Instead, the system may provision resources to users automatically in response to specified events that may originate from entities other than those users. For example, when a new employee or contractor joins an organization, an event originating from the human resources department may indicate the role that the person will play in the organization. Depending on the role, the system may responsively provision, to the person, a set of resources that are associated with that role. For example, based on the person's role, the person may be given a cube, a virtual machine, etc., without waiting for any approval from anyone else in the organization. Similarly, when the person leaves the organization or moves to a different role in the organization, access to certain resources may be automatically revoked or changed depending on the corresponding event.

### Data Model for Resource Provisioning Engine

According to one embodiment of the invention, the unified generic resource provisioning system stores all of its data in conformity with a specified data model. The data model specifies a format for the attributes of all resources provisioned by the system. The data model is sufficiently flexible that data for any type of resource may be stored in conformity with the format specified by the data model. For example, both data pertaining to a virtual machine resource and data pertaining to a Single Sockets Layer (SSL) certificate may be stored in conformity with the data model. For another example, data pertaining to more physical resources, such as cubes and telephones, also can be stored in conformity with the same data model.

In one embodiment of the invention, the data model includes three sub-models: the resource data model, the approval data model, and the request data model. Each of these sub-models is discussed below.

The resource data model defines the format to which data describing actual resources conforms. Resources are hierarchical and abstract in nature. The resource data model defines an expiration date, license count, and other resource attributes. The resource data model defines multiple different levels of authorization and privileges for resources, such as “view only” privileges and “administration” privileges. Users are associated with resources through user identifiers and resource identifiers that may be stored along with other data pertaining to those resources. The metadata associated with a resource includes an “item” property that defines the type of that resource. For example, a resource's type could be “virtual machine” or “SSL certificate.” Items are either composed of item properties, which in turn have a template, or are compositions of data attributes which may be simple name value pairs. For a particular resource type, the designer of that resource type can choose to represent that type's attributes or properties using either data attributes or templates (“items”).

Approvals also have a data model. In one embodiment of the invention, approvals are the mechanism through which a user is given access to a resource. A designer of a particular approval can configure that approval by defining approval metadata for that particular approval. The resource data model may associate a particular approval with a particular resource or an item, which, as discussed above, may be a template for a resource.

In one embodiment of the invention, each approval has a stage header. A stage header contains data that indicates, to the unified generic resource provisioning system, the specific set of actors (potentially other users or systems) who need to approve access to a resource before a request for that resource can be granted. Approval stage headers define the metadata for approvals which can be either linear or hierarchical.

Users request access to resources through requests, which conform to the request data model. A user trying to obtain access to a resource drives the approval functionality through a user interface. Once the user enters all of the relevant details for the resource to be requested, and potentially the project for which the resource is being requested, that user submits the request to the unified generic resource provisioning system. A request application programming interface is used to associate approvals with target objects, such as resources, accounts, etc. Request objects are composite in nature. Requests tie together approvals and request targets, such as resources. In one embodiment of the invention, requests can be used to request access to objects other than resources per se, such as privilege objects or account objects, for example.

In one embodiment of the invention, an authorization data model is also separately defined. Authorizations may be associated with resources. An authorization may indicate, for the resource with which that authorization is associated, (a) a set of users that have “view” level authorization for the associated resource, and (b) a set of users that have “admin” level authorization for that resource. In one embodiment of the invention, users with “view” level authorization can see or read, but cannot modify, a resource's associated data. In one embodiment of the invention, users with “admin” level can see, read, write, and modify a resource's associated data. “Admin” level authorization is typically given to system administrators, while “view” level authorization is typically given to other, normal users. In one embodiment of the invention, each user may be limited to the performance of actions from a set of specified actions relative to a particular resource. The set of actions to which a particular user is limited may depend at least in part on the groups or projects with which that particular user is associated. For example, everyone associated with a project might be able to view resources that are also associated with that project. However, other than a defined administrator for the project, those users are restricted from approving whether a resource should be allocated to a particular person associated with that project.

The data models described above function to associate user with resources. Multiple users may be associated with a particular resource, and multiple resources may be associated with a particular user.

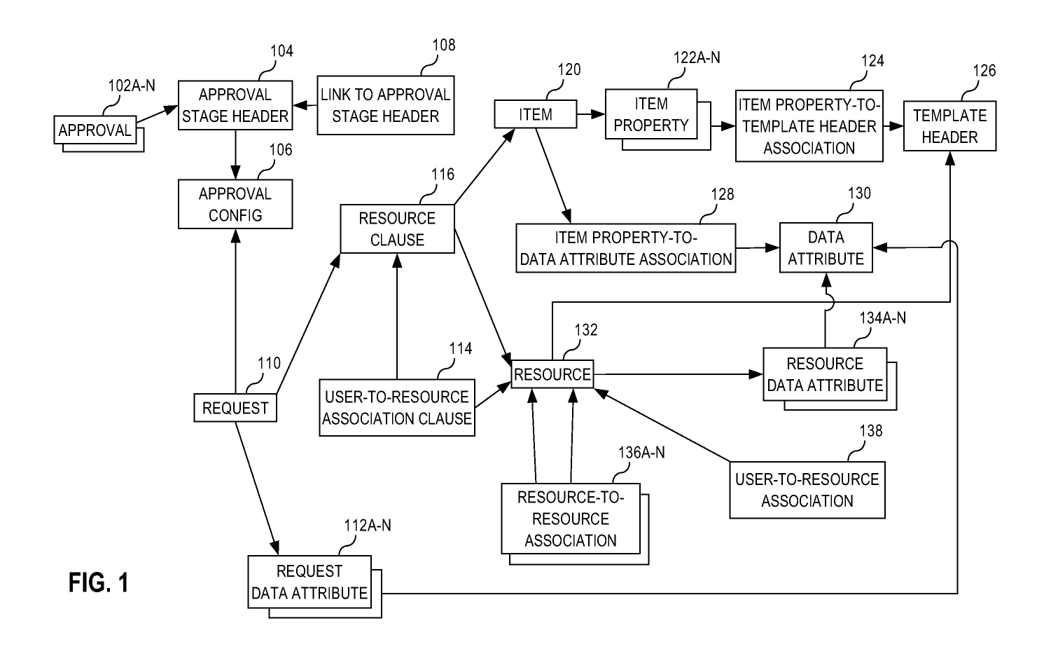

FIG. 1 is a block diagram that illustrates an example of a data model that defines various object types and the relationships between those object types, according to an embodiment of the invention. Approvals 120A-N are mapped to an approval stage header 104. Approval stage header 104 is mapped to an approval configuration 106. An aggregate link to approval stage header 108 maps to approval stage header 104 and also to an item 120. Together, objects 102A-N through 108 form the approval data model.

Request 110 is also mapped to approval configuration 106. Request 110 is further mapped to request data attributes 112A-N. A user-to-resource association clause is mapped to a resource clause 116. Together, objects 110 through 114 form the request data model.

Resource clause 116 is mapped to both an item 120 and a resource 132. Item 120 is mapped to item properties 122A-N and an item property-to-data attribute association 128. Item properties 122A-N are mapped to an item property-to-template header association 124. Item property-to-template header association 124 is mapped to template header 126. Item property-to-data attribute association 128 is mapped to a data attribute 130. Together, objects 120 through 130 form metadata that defines resource types.

Resource 132 is mapped to both template header 126 and resource data attributes 134A-N. Resource data attributes are mapped to data attribute 130. Resource-to-resource associations 136A-N map different instances of resource 132 to each other. A user-to-resource association 138 is also mapped to resource 132. Together, objects 132 through 138 form the resource data model.

### Example Uses of the Resource Data Model

Following is a discussion of different specific types of resources that might be found in an example of the unified generic resource provisioning system, and the kinds of data that might be stored in association with each type.

A resource may be a virtual machine, and may be of a virtual machine type. In one embodiment of the invention, each virtual machine is associated with both a domain and one or more subdomains. For example, a domain could be a department and a subdomain could be a project. In one embodiment of the invention, each project is also associated with one or more sub-projects. Each project or sub-project may be associated with any number of separate virtual machines. In one embodiment of the invention, each virtual machine has an associated template that identifies a specific type of that virtual machine, of a plurality of virtual machine types. For example, one virtual machine type may be “medium,” which is associated with a specified quantity of persistent storage space. In one embodiment of the invention, each virtual machine has associated license data (which may conform to a separate license data model). This license data may indicate a current quantity of licenses that are associated with that virtual machine. In one embodiment of the invention, each virtual machine has an associated state. The state indicates the current status of the virtual machine, and may be set to “stop,” “start,” or “running” states. Like other types of resources, virtual machines may be associated with sets of users and/or sets of defined user groups.

A resource may be an SSL certificate, and may be of an SSL certificate type. In some embodiments of the invention, certificates other than SSL certificates also may be defined as resources, and the data model may specify a different resource type for each different type of certificate. In one embodiment of the invention, the unified generic resource provisioning system is used to provision SSL certificates (and potentially other kinds of certificates) to users. Because certificates are of a resource type that differs from the virtual machine resource type, certificates may be associated with different sets of attributes and properties than the sets of attributes and properties with which virtual machines are associated. In one embodiment of the invention, each certificate is associated with an owner and a chain of other certificates. Because the data model is generally hierarchical in nature regardless of the type of resource being represented by the data model, the hierarchical data model can be used to maintain data that represents relations between certificates in a certificate chain.

The data model may be used to define associations between two or more resources of any resource type. The content for each resource may be stored in tables that are separate from the tables that store the hierarchical data; the hierarchical data may, for example, contain references to various rows in these separate tables. Separating data in this manner has some advantages. The content stored in the separate table may serve as a container for holding references to other resources, or that content may represent the actual attributes of a single resource. If the type of resource is “certificate,” then the content stored for that certificate may include a byte array stored as a character large object (CLOB) in a database. However, it should not be supposed that embodiments of the invention are limited to relational data models. Virtually any kind of database or data store may be used to store resource data.

### Templates

In one embodiment of the invention, each resource is associated with a separate template, although a particular template might be associated with more than one resource. Templates loosen the coupling between a resource and the type of that resource. Metadata defines the resource type but, instead of being contained directly within the resource's own data, is associated with either a template or a set of data attributes that are external to the data stored for that resource. The use of templates in this manner helps separate the properties of a resource from the behavior of that resource.

### Example Relational Tables for Storing Resource Data

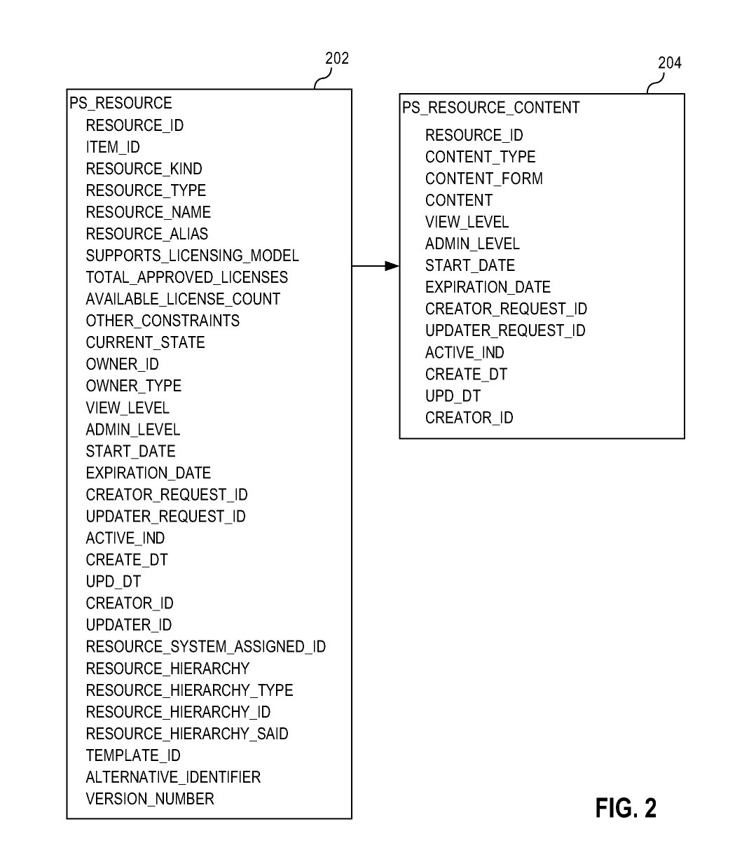

FIG. 2 is a block diagram that illustrates example names and purposes of various columns in a resource table and a resource content table, according to an embodiment of the invention. FIG. 2 shows resource table 202 and resource content table 204. It should be noted that alternative embodiments of the invention may store resource data within files rather than within a database. Fields within tables 202 and 204 are discussed below.

As is discussed above, in one embodiment of the invention, at least some resources support a licensing model. A project can be associated with multiple virtual machines, each with a corresponding license. At any point in time, a resource may be associated with a total number of approved licenses (obtained in response to resource requests being granted) and a total number of available licenses (indicating how many more requests for that resource may be granted). However, not all resources are required to support a licensing model.

In one embodiment of the invention, each resource may also have one or more associated aliases. An alias is an alternative name for a resource that may be used to refer to that resource. For example, a particular virtual machine might have an alias such as “projectA_{—VM}1” which a user might use, instead of that particular virtual machine's Internet Protocol (IP) address, to refer to that particular virtual machine.

In one embodiment of the invention, each resource also may have an associated state. The current state field indicates the latest state of the resource. The current state field may be updated automatically and in real-time by a back-end resource service provider with which the unified generic resource provisioning system interacts. Such a back-end resource service provider might be, for example, a SSL certificate provider or a virtual machine provider. If the resource is a virtual machine that is currently being started, state transitions can happen very quickly. Therefore, in one embodiment of the invention, the unified generic resource provisioning system keeps a channel open with all back-end systems with which it interacts so that updated resource state information can be synchronized quickly.

In one embodiment of the invention, each resource is also associated with an owner. In one embodiment of the invention, a user with administrator privileges is permitted to proxy the ownership of a resource to someone other than the owner who is specified by the value of the owner identifier filed.

In one embodiment of the invention, each resource is associated with an ownership level or owner type. The owner type might be “admin” or “user,” for example. An “admin” type of owner might own all of the virtual machines and SSL certificates that belong to a group, while a “user” type of owner might only be permitted to perform a specified set of operations relative to the resource.

In one embodiment of the invention, each resource is also associated with one or more locks. Locks on resources may include soft locks and/or hard locks. Soft locks ensure that concurrent users are not editing the same resource simultaneously. A particular user may be granted a lock on a resource. While that lock is granted to the particular user, the system may allow the particular user to modify data associated with the resource, but prevent users other than the particular user from modifying data associated with the resource. Later, the lock on the resource may be released. While the resource's lock is not granted to any user, another user is allowed to obtain a lock on the resource.

In one embodiment of the invention, each resource is also associated with a system-defined identifier, or “SAID” that is a unique key that associates a provisioning request with a back-end service provider that is able to provide to resource requested by that provisioning request. In such an embodiment, whenever such a back-end service provider interacts with the unified generic resource provisioning system, it does so with reference to a request identifier and the SAID. The request identifier is generated by the unified generic resource provisioning system, while the SAID is generated by the back-end service provider in response to the first time that a request is submitted to the back-end service provider.

Each resource has an associated unique resource identifier that is stored in resource table 202. In one embodiment of the invention, the same resource identifier is also stored in resource content table 204, and is used to cross-reference between table 202 and table 204. Resource content table 204 contains the actual content (rather than metadata) for the resource. For example, the actual content of an SSL certificate may be stored in resource content table 204. The actual content may be represented with content table 204 as a set of name-value pairs.

### Example Overall Provisioning Technique

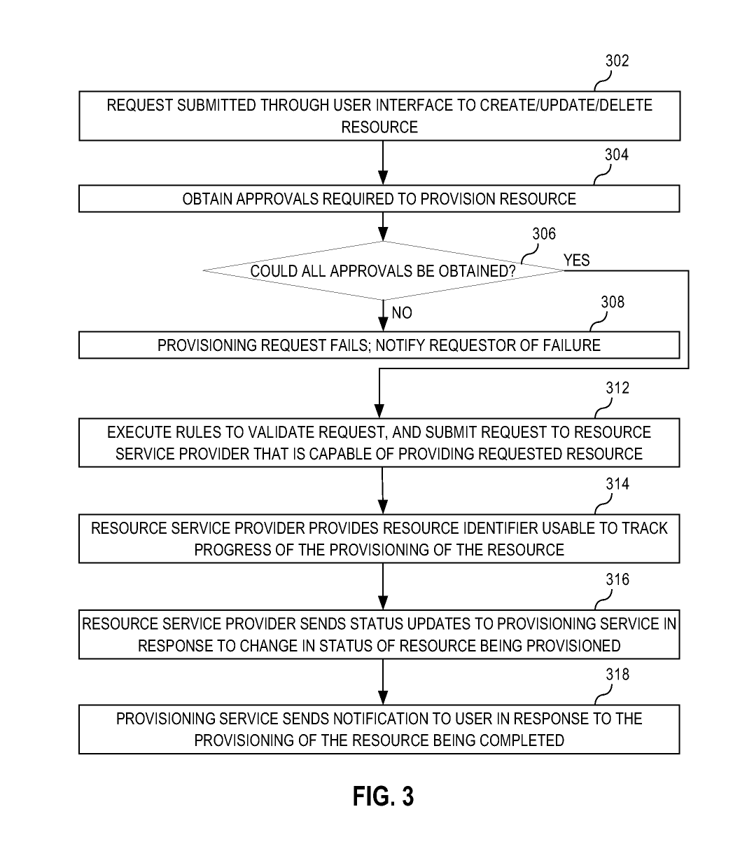

FIG. 3 is a flow diagram that illustrates a high-level example of a technique for provisioning a resource to a user via the unified generic resource provisioning system, according to an embodiment of the invention. Alternative embodiments of the invention may include additional, fewer, or different steps than those discussed below with reference to FIG. 3.

In block 302, a user submits a request through a user interface tool of the unified generic resource provisioning system. This tool gathers all the information about the resource to which the user seeks access. This could be information about a virtual machine or a project and the approvals needed before that virtual machine can be provisioned to the user. Once all the information is entered, a request object is created. The request object ties an approval object together with a resource object through a loosely coupled composition model. In block 304, the unified generic resource provisioning system attempts to obtain the required approvals (from various approval object-specified users and/or systems) that need to be obtained before the requested resource can be provisioned to the user. In block 306, the unified generic resource provisioning system determines whether all of the required approvals have been obtained. If all of the required approvals have been obtained, then control passes to block 312. Otherwise, control passes to block 308.

In block 308, if less than all of the required approvals can be obtained, then the request submitted in block 302 fails; the unified generic resource provisioning system may send a notification (in one embodiment of the invention, using the notification system disclosed in U.S. patent application Ser. No. 13/287,973) to the requesting user indicating that the user's request for the resource has been denied.

Alternatively, in block 312, if all of the required approvals are obtained, then the unified generic resource provisioning system (or a back-end system thereof) executes certain rules to ensure that the request is valid. For example, one system rule might state that a project cannot have more than 10 virtual machines. Under such circumstances, if a user submits a request to obtain an 11th virtual machine for the same project, then the unified generic resource provisioning system will reject the request. The unified generic resource provisioning system can use any rule engine to execute simple or complex rules that decide whether the request is valid. In one embodiment of the invention, all approvals are acquired before the rule checking begins.

Once the request passes all the required rules or constraints, in block 314, the unified generic resource provisioning system routes the request to the back-end resource service provider that triggers the actual call to either create, update, or delete the resource (depending on the specific request). For example, for resource provisioning, the resource service provider will call cloud-based application programming interfaces to create a virtual machine. Similarly, for certificates, the same “create” call will send the certificate creation data to a cloud-based application programming interface to create a server or client certificate.

The resource service provider called in this manner might not instantaneously create the resource. Once the call to the resource service provider has been dispatched, however, in block 314, the resource service provider sends a resource identifier to the unified generic resource provisioning system so that the unified generic resource provisioning system can track the provisioning of the resource. The resource identifier and request identifier then become the unique keys that the unified generic resource provisioning system uses to track the resource.

In block 316, in response to the resource changing state (for example, a virtual machine moving from the “starting” state to the “started” state), the resource service provider sends real-time synchronization events to the unified generic resource provisioning system so that the unified generic resource provisioning system can update its data with the latest state of the resource (as is discussed above, in one embodiment of the invention, each resource is associated with a current state). Depending on the current state of the resource, the performance of certain operations relative to the resource might or might not be possible at a particular moment in time.

Finally, in block 318, the unified generic resource provisioning system notifies (in one embodiment of the invention, using the notification system disclosed in U.S. patent application Ser. No. 13/287,973) the user that the resource has been provisioned. The unified generic resource provisioning system may do so in response to receiving a corresponding status event from the resource service provider. Thereafter, for as long as the resource remains provisioned to the user, the user can perform any authorized actions relative to the resource.

### Detailed Data Model

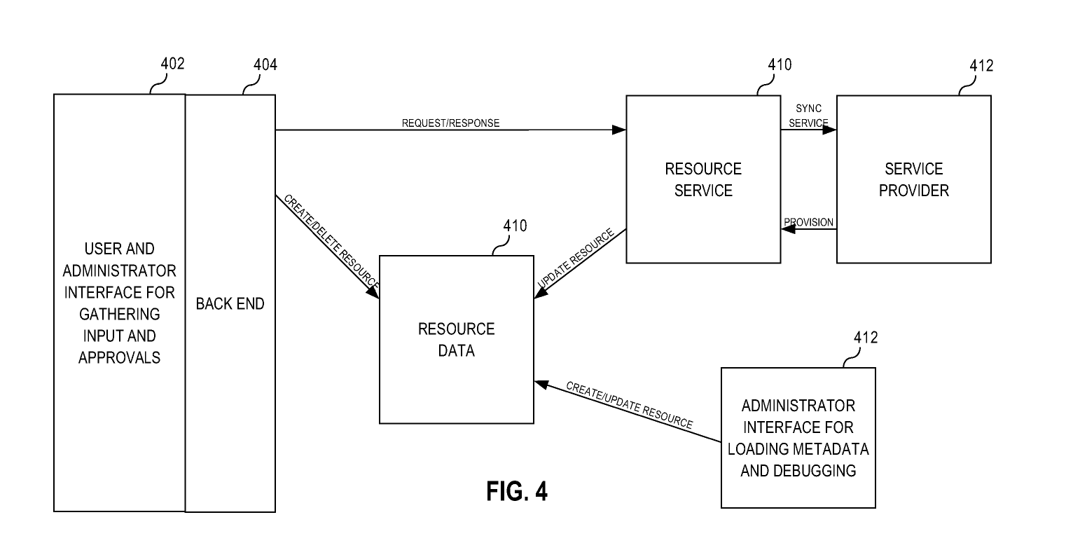

FIG. 4 is a block diagram that illustrates a more concrete representation of work flows using the data model illustrated in FIG. 1, according to an embodiment of the invention. Referring to FIG. 4, a user interface 402 gathers resource data and submits that resource data to a back-end system 404 after all approvals are obtained. Back-end system 404 submits requests to, and receives responses from, a resource service 406. Resource service 406 executes all rules for the resource and submits the request to a back-end resource service provider 408. Resource service 406 can submit requests to a variety of different kinds of resource service providers, including cloud providers, SSL certificate providers, badge providers, etc., through the same set of application programming interfaces. Resource service provider 408 sends real-time status updates regarding the requested resource back to resource service 406. Resource service 406 updates the state information about the resource within resource data 410 stored in a central database shared by front-end and back-end components of the unified generic resource provisioning system. In one embodiment of the invention, JAVA Architecture for XML Binding (JAXB) or Rest Easy clients are used to implement one or more system components, but this is optional. Any protocols and technology stacks can be used to send the request to back-end system components; examples include Hypertext Transfer Protocol (HTTP), Transport Communication Protocol (TCP), JAVA servlets, etc.

In one embodiment of the invention, back-end system 404 also records, in resource data 410, the license counts that are available for a project to use after the request is submitted. In embodiments of the invention the employ resource locking (as discussed above), the locking model is optimistic, meaning that the license counts are decremented in a hope that the request will succeed by resulting in the provisioning of the resource. If the request fails for any reason, then the license counts are incremented again to reflect the correct values.

In one embodiment of the invention, the unified generic resource provisioning system includes an administrator user interface 412 that an administrator of the system can use to load resource metadata from resource data 410 and use that data to debug the system, generate reports based on resource data 410, etc.

### Locking and License Count Reconciliation

Potentially, multiple browser sessions or users could try to access the same resource concurrently. It is not very practical for the unified generic resource provisioning system to wait for the multiple requests to be reconciled with correct license counts on the back-end system components or in the central database. Therefore, in one embodiment of the invention, the unified generic resource provisioning system reconciles license counts for a resource even before the request for the resource is submitted. This reconciliation can be accomplished through the use of two types of locks: soft locks and hard locks.

The first type of lock is a soft lock. The unified generic resource provisioning system may be implemented as a set of separate, concurrently executing system server instances. While a resource is being edited by a user or HTTP session, the resource's license count is decremented and immediately broadcast to all other system servers to reflect the same license count number. The resource is soft-locked for a temporary period of time until the request for the resource has been fully submitted. This means that if the user forgets to complete the request session within a specified time period, the unified generic resource provisioning system will release the lock automatically. The broadcast event may send any state change information related to the resource or project (containing multiple resources) to other system servers through a flexible protocol that tells the other system servers which variable is being changed. The protocol may be used to also communicate, to the other system servers, a vector that defines the direction of state change (e.g., positive or negative).

The second type of lock is a hard lock. Once a request has been submitted to a back-end component of the unified generic resource provisioning system and is being processed, hard locks are enabled to ensure that no other user can access that resource until the provisioning of the resource has been completed by the resource service provider. Before the provisioning of the resource is complete, unless the resource service provider sends an error message through a real-time synchronization event, the resource remains hard-locked.

### Hierarchical Resource Access

In one embodiment of the invention, some resource types are hierarchical. For example, a project could have sub-projects that include multiple resources; in one embodiment of the invention, both “project” and “sub-project” are separate resource types that may be parents of other resource types in a hierarchy of resources. There is no limitation on the quantity of levels of nesting that resources can have. Similarly, certificates could have certificate chains that may be deeply nested. A resource could also be associated with different resource content at each level of a hierarchical tree. Different scopes of user access to resources at different levels of the tree may be provided at any level of the tree through resource attributes set at that particular level. Such attributes may include “admin” authorization level access or “view” authorization level access. For example, a highest level of the tree, containing the root node, might be associated with one set of authorizations, while a second level of the tree, containing three child nodes of the root node, might be associated with a second set of authorizations, which a third level of the tree, containing two child nodes that are children of one or more second-level nodes, might be associated with a third set of authorizations, where the first, second, and third sets of authorizations are all different from each other. Each node in the tree may be associated with a separate resource.

### Client and Resource Service Integration

In one embodiment of the invention, a user interface-providing client component of the unified generic resource provisioning system interacts with back-end resource service providers through a generic application programming interface (API) that can be used to interact with any type of resource service provider (e.g., virtual machine provider, SSL certificate provider, security badge provider, etc.). Following is a list of some of the methods that are exposed by the generic API in one embodiment of the invention, along with a brief discussion of the functions of those methods.

1. ResourceService.createResourceQ: This method takes a ResourceRequest object as input and returns a ResourceResponse object as output. This method is used to create a new resource.

2. ResourceService.deleteResourceQ: This method deletes a resource from a resource provider and from the provisioning system but retains (e.g., in the central database) an audit trail for the resource to be tracked later. Such an audit trail may include all previously existent versions of the resource.

3. ResourceService.updateResourceQ: This method updates a resource in the provisioning system and a resource provider.

4. ResourceService.fetchResourceQ: This method retrieves and returns, from the central database, the resource that is specified by the resource identifier passed as input to the method.

5. ResourceService.findResourceQ: This method retrieves and returns, from the central database, all resources that contain data that match a specified pattern passed as input to the method.

6. ResourceService.purgeResourcesQ: This method purges all resources from a cache of the unified generic resource provisioning system, or, in an alternative embodiment of the invention, resets such a cache.

### Generic Communication Envelope

Since the unified generic resource provisioning system communicates with back-end resource service providers that are diverse, in one embodiment, a generic request/response envelope is used for all such communications. This generic envelope enables the unified generic resource provisioning system to interact with any resource service provider without requiring any code of any resource service provider to be changed. In the example request/response envelope illustrated below, additional<ADATA>attributes can be used to send any information to and receive any information from the target resource service provider. The provider could be provisioning virtual machines, certificates, phones, cubes, etc. The following is a concrete example of a request/response envelope, according to an embodiment of the invention:

<?xml version=“1.0” encoding=“UTF-8”?>
<REQ>

| ! | <HDR> | |
|---|---|---|
| ! | ! | <AID>500</AID> |
| ! | ! | <AKEY>444332</AKEY> |
| ! | ! | <APWD>444332</APWD> |
| ! | ! | <TXN>D1000646319_1000010791_1004_lamb.corp_10-05-2011 |
| ! | ! | </TXN> |
| ! | ! | <API>Create</API> |
| ! | ! | <SRVC>Virtual Machine</SRVC> |
| ! | ! | <ACCNT>PROV_USER_DS</ACCNT> |
| ! | ! | <ACCNTPASSWD>the company123</ACCNTPASSWD> |
| ! | </HDR> | |
| ! | <RSRCLST> | |
| ! | ! | <RSRC>. |

### Example User Interfaces

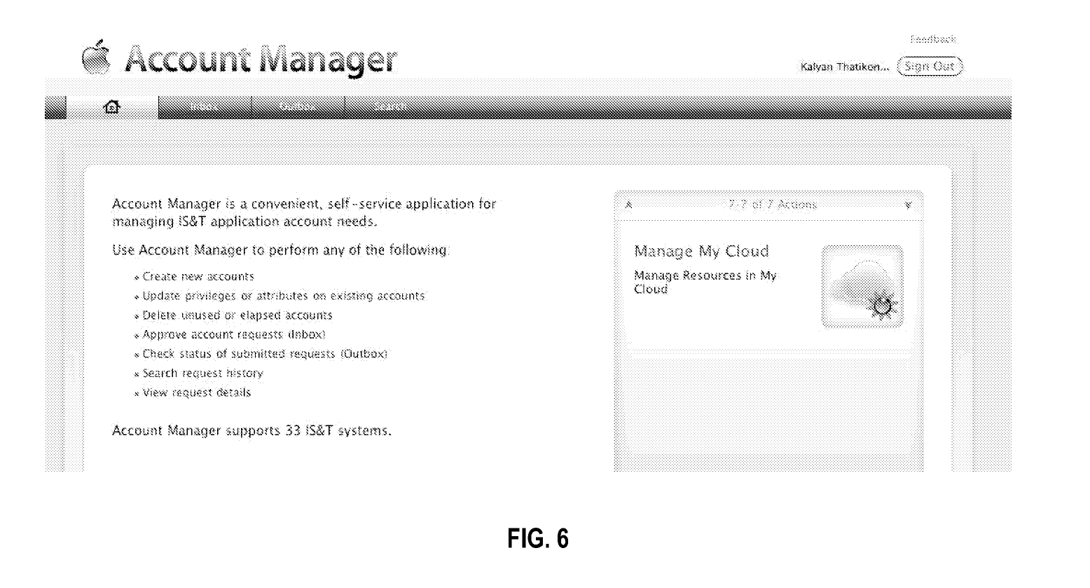

As is discussed above, the resource provisioning system can be used to provision a variety of different types of resources, including a virtual machine. FIGS. 6-16 are diagrams that collectively illustrate a series of user interfaces through which a user can submit a request for a new virtual machine resource, specify the details of that request, and view the status of that request, according to an embodiment of the invention.

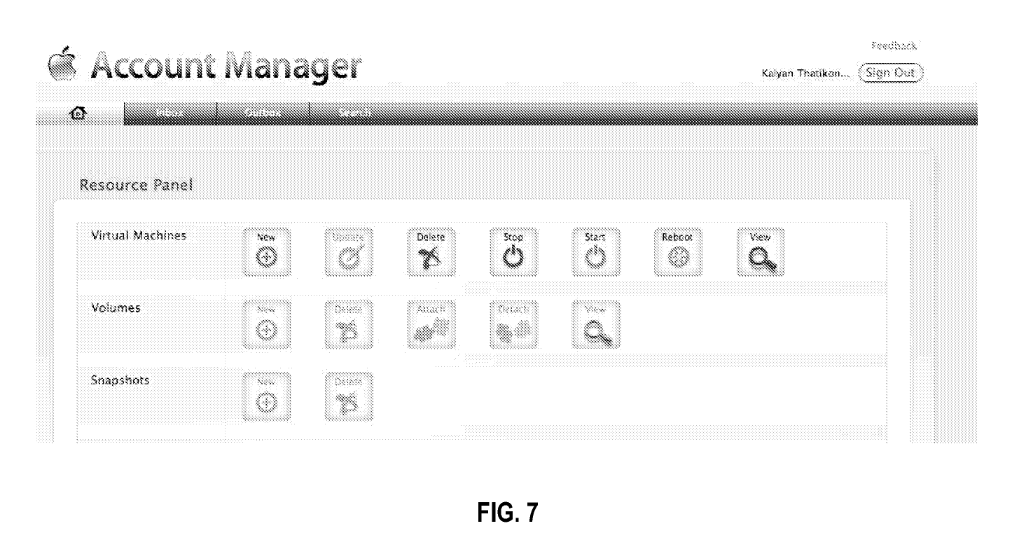

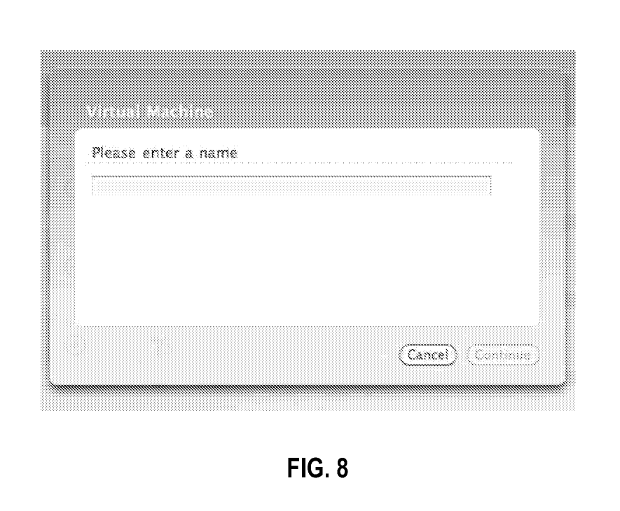

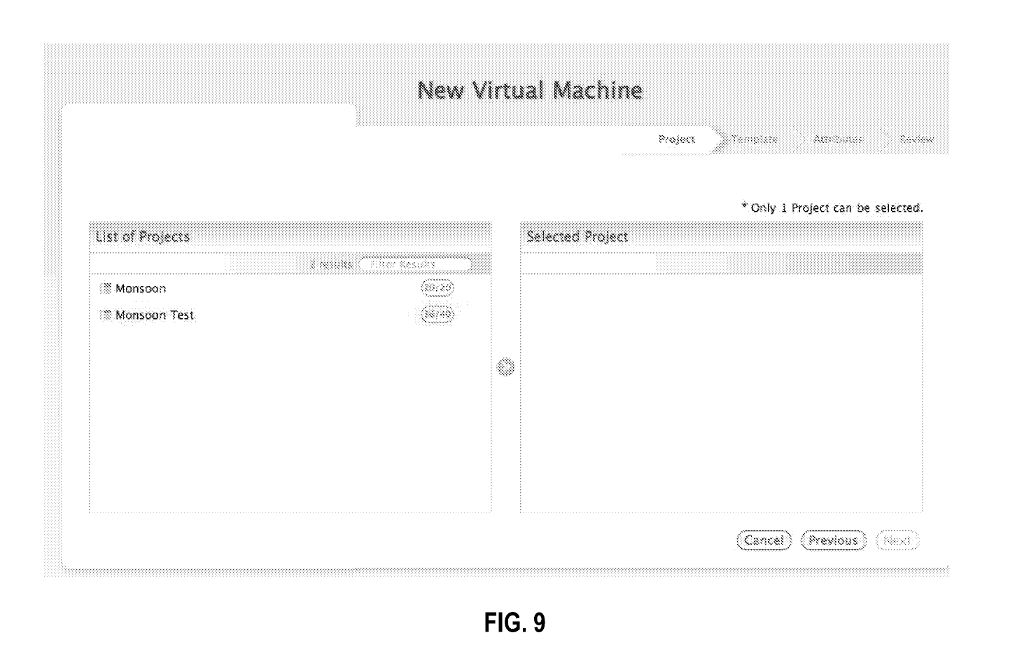

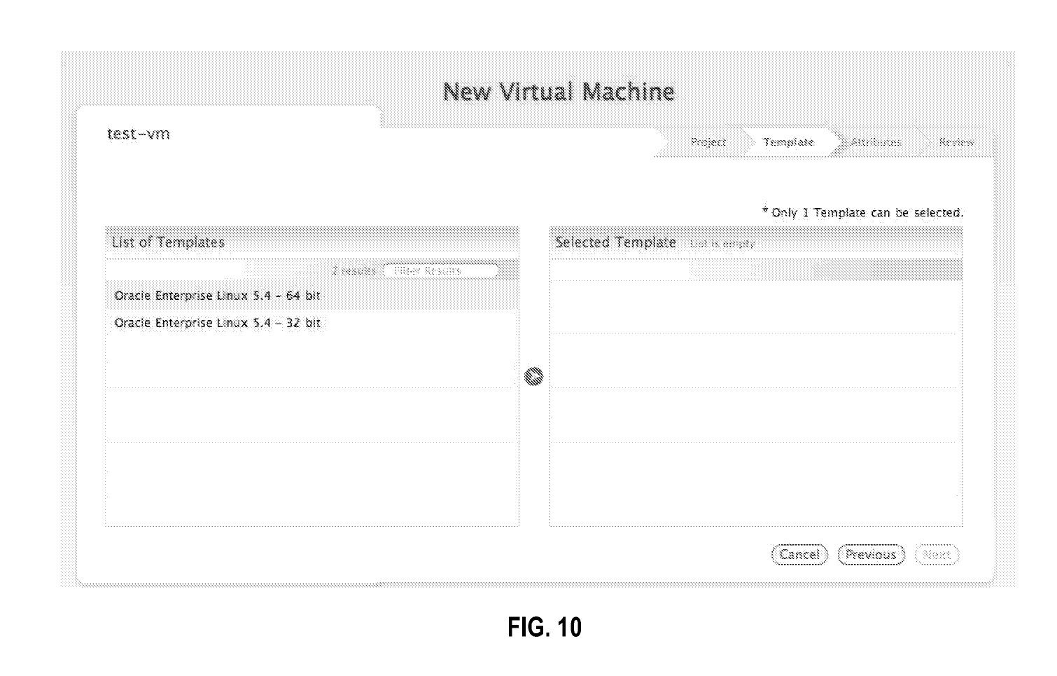

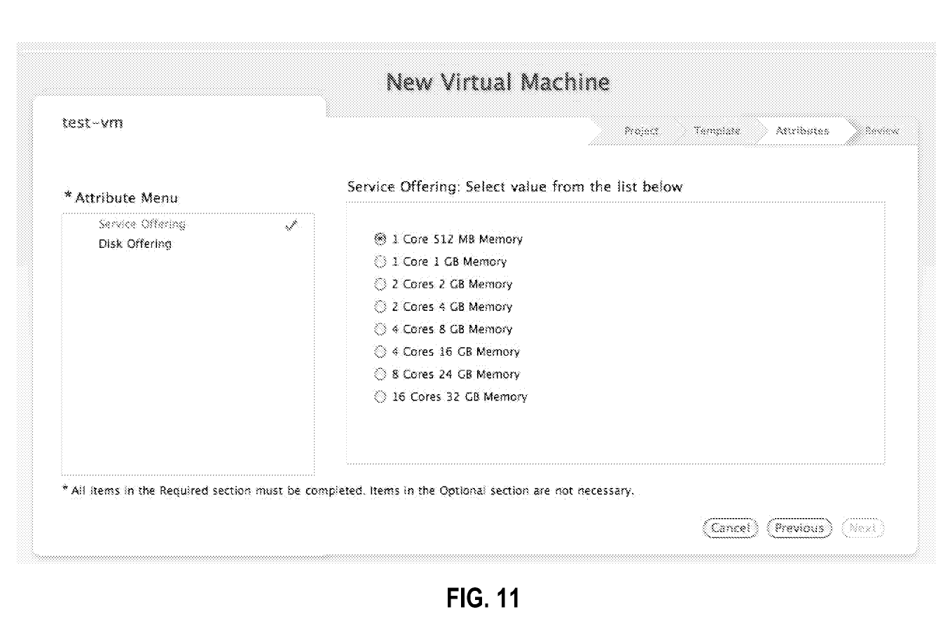

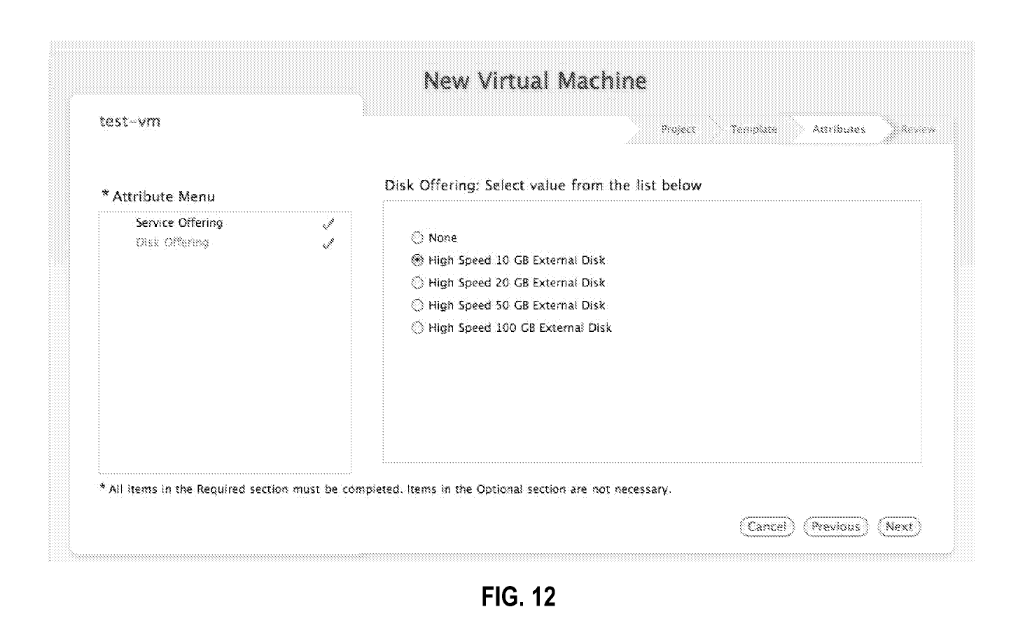

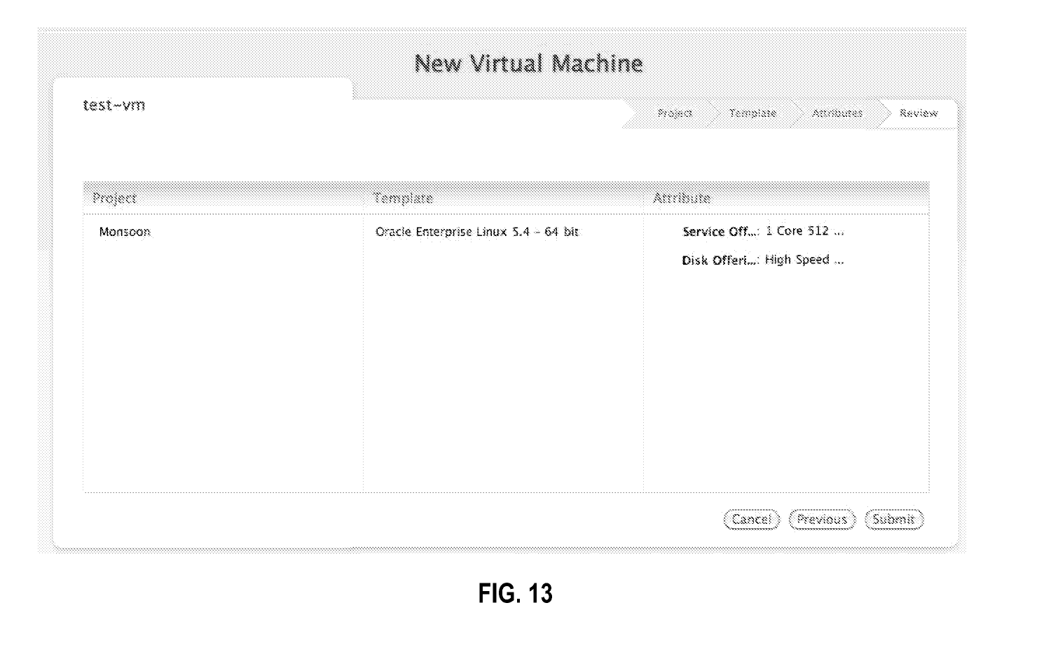

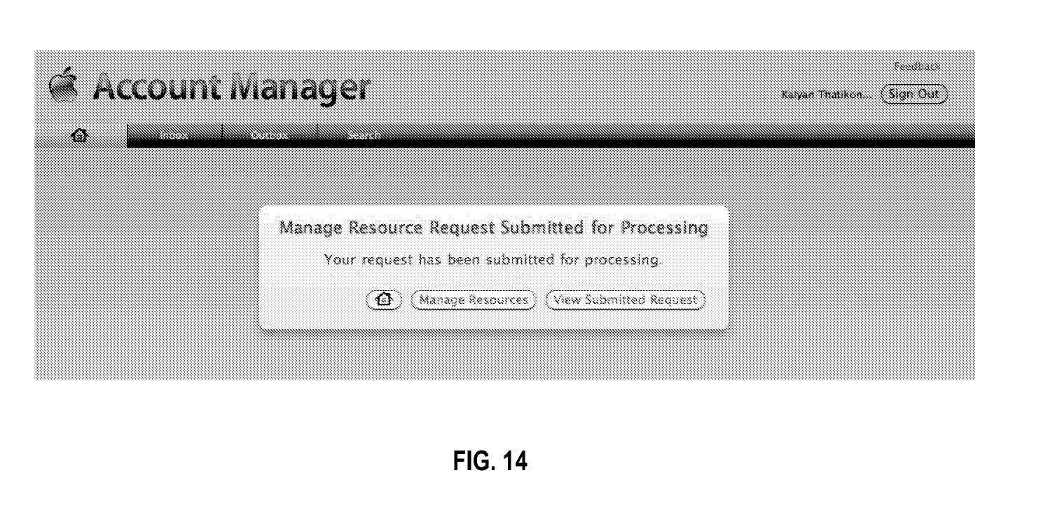

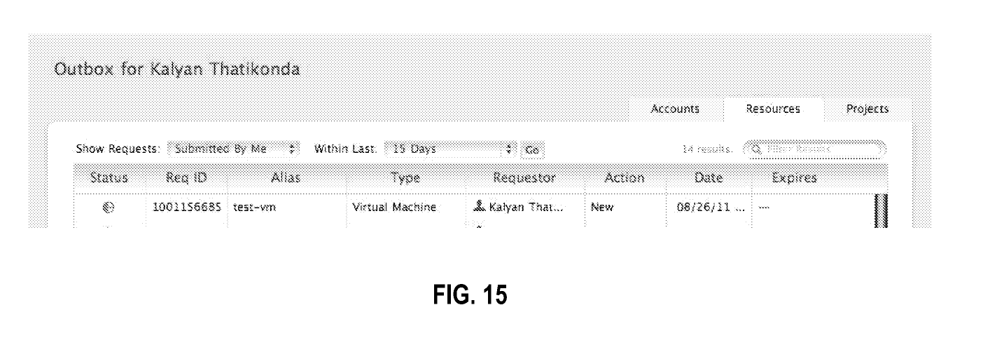

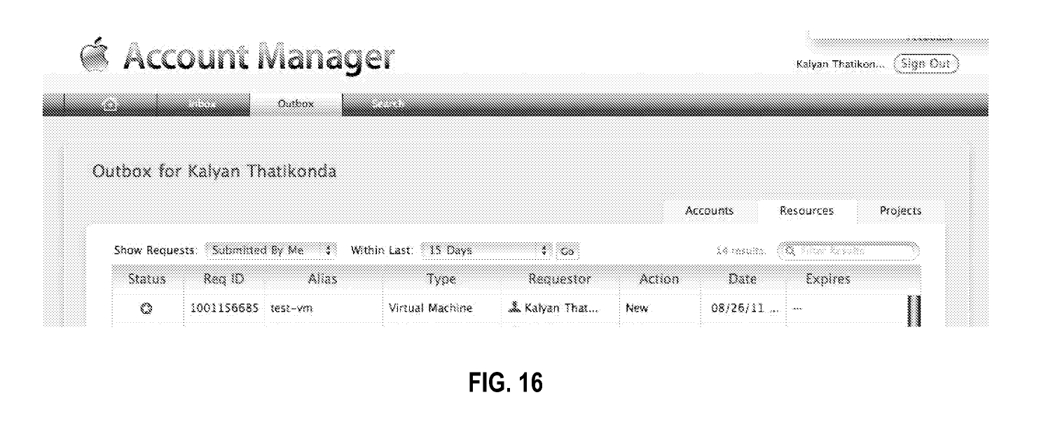

FIG. 6 is a diagram that illustrates an example of a user interface through which a user can begin managing resources in his cloud by selecting a “manage my cloud” icon, according to an embodiment of the invention. FIG. 7 is a diagram that illustrates an example of a user interface through which a user can request the provisioning of a new virtual machine resource by selecting a “new” icon in a “virtual machine” row, according to an embodiment of the invention. FIG. 8 is a diagram that illustrates an example of a user interface through which a user can enter the name that will be assigned to the new virtual machine resource that he is requesting, according to an embodiment of the invention. FIG. 9 is a diagram that illustrates an example of a user interface through which a user can select a project for which the new virtual machine resource will be provisioned, according to an embodiment of the invention. FIG. 10 is a diagram that illustrates an example of a user interface through which a user can select a template that will be used to create the new virtual machine, according to an embodiment of the invention. FIG. 11 is a diagram that illustrates an example of a user interface through which a user can select a service offering, including a quantity of cores and a memory size, for the new virtual machine, according to an embodiment of the invention. FIG. 12 is a diagram that illustrates an example of a user interface through which a user can select a disk offering, including a disk size, for the new virtual machine, according to an embodiment of the invention. FIG. 13 is a diagram that illustrates an example of a user interface through which a user can review his specified attributes for the new virtual machine before submitting his request for the new virtual machine to the resource service provider, according to an embodiment of the invention. FIG. 14 is a diagram that illustrates an example of a user interface through which a user can request to view a current status of his submitted request for the new virtual machine by selecting a “view submitted request” option, according to an embodiment of the invention. FIG. 15 is a diagram that illustrates an example of a user interface through which a user can view the pending-approval status icon of his submitted request for the new virtual machine, according to an embodiment of the invention. FIG. 16 is a diagram that illustrates an example of a user interface through which a user can view the provisioning-completed status icon of his submitted request for the new virtual machine, according to an embodiment of the invention.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

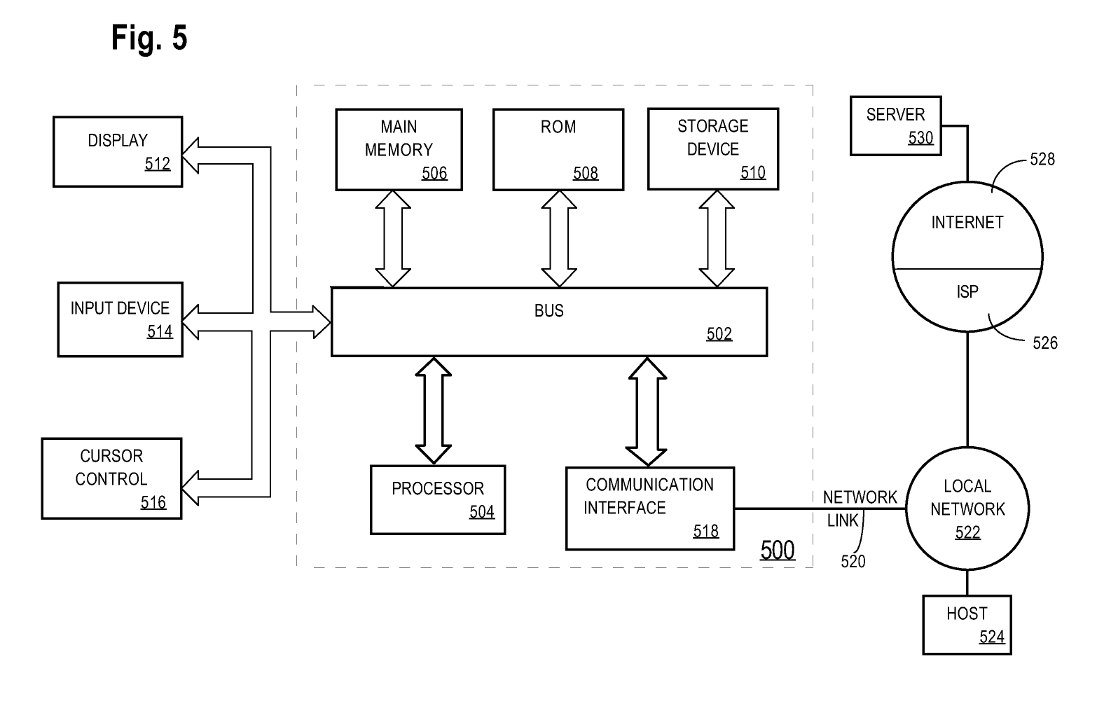

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method comprising:
in response to detecting an occurrence of a first type of event relative to a user, automatically provisioning, to the user, access to at least (a) a first resource that is of a first resource type and (b) a second resource that is of a second resource type that differs from the first resource type; and
in response to detecting an occurrence of a second type of event relative to the user, automatically revoking, from the user, access to both the first resource and the second resource;
wherein said first resource is a specific instance of an abstract resource concept;
wherein said second resource is a specific instance of said abstract resource concept;
wherein said provisioning and said revocation are performed by a system that unifies a data model, a resource privilege model, and a user interface; and
wherein the method is performed by one or more computing devices.

2. The method of claim 1, wherein:
the step of provisioning access to the first resource and the second resource comprises provisioning, to the user, access to at least a telephone, a security badge, a cube, a virtual machine, and a Single Sockets Layer (SSL) certificate; and
the step of revoking access to the first resource and the second resource comprises revoking, from the user, access to at least said telephone, said security badge, said cube, said virtual machine, and said SSL certificate.

3. The method of claim 1, further comprising:
revoking, from the user, access to a third resource in response to determining that a lease expiry date stored within data associated with the third resource has passed.

4. The method of claim 1, further comprising:
storing data that identifies a first user as an owner of the first resource;
in response to receiving user association information from the first user, storing data that indicates that the first resource is associated with a second user who is separate from the first user;
in response to receiving user permission data from the first user, storing data that indicates a set of operations that the second user is allowed to perform relative to the first resource; and
in response to detecting an attempt by the second user to perform, relative to the first resource, a particular operation that is not contained in the set of operations, preventing the particular operation from being performed relative to the first resource.

5. The method of claim 1, further comprising:
granting, to a particular user, a lock on the first resource;
while the lock on the first resource is granted to the particular user, (1) allowing the particular user to modify data associated with the first resource and (2) preventing users other than the particular user from modifying data associated with the first resource;
releasing the lock on the first resource; and
while the lock on the first resource is not granted to any user, allowing a user to obtain the lock on the first resource.

6. The method of claim 1, further comprising:
in response to the first resource changing from a first version of the first resource to a second version of the first resource, storing and retaining first version data that indicates a state of the first version of the first resource and also storing second version data that indicates a state of the second version of the first resource.

7. A computer-implemented method comprising:
receiving, from a user, a first request to provision a specified resource for use in a specified project;
in response to the first request, determining, based on a particular rule within a set of stored rules, whether less than a specified maximum quantity of resources of a same type as a particular type of the specified resource have been provisioned for use with the specified project; and
in response to determining that less than the specified maximum quantity of resources of the particular type have been provisioned for use with the specified project, forwarding the first request to a service provider that provisions resources of the particular type; and
in response to the service provider provisioning a resource of the particular type, updating stored data that indicates a quantity of resources of the particular type that are currently provisioned for use with the specified project;
wherein the method is performed by one or more computing devices.

8. The method of claim 1, further comprising:
persistently storing, within a historical repository, (a) first data that indicates details of a first entity that represents the first request, (b) second data that indicates details of a second entity that represents the specified resource, and (c) third data that indicates details of a third entity that represents an approval of the first request; and
generating a report that specifies at least some of the first data, at least some of the second data, and at least some of the third data.

9. A computer-implemented method comprising:
storing data that defines a hierarchical tree of nodes in which at least some nodes are associated with one or more resources and one or more users;
in response to a request, from a first user, to access a particular resource that is associated with a particular node of the tree, determining whether the first user is associated with a node that is either the particular node or an ancestor of the particular node in the tree; and
in response to determining that the first user is associated with a node that is either the particular node or an ancestor of the particular node in the tree, granting the first user access to the particular resource;
wherein the method is performed by one or more computing devices.

10. The method of claim 9, further comprising:
in response to a request, from a second user, to access the particular resource that is associated with the particular node of the tree, determining whether the second user is associated with a node that is either the particular node or an ancestor of the particular node in the tree; and
in response to determining that the second user is not associated with a node that is either the particular node or an ancestor of the particular node in the tree, denying the second user access to the particular resource.

11. One or more storage media storing instructions which, when executed by one or more processors, causes performance of the method recited in claim 1.

12. One or more storage media storing instructions which, when executed by one or more processors, causes performance of the method recited in claim 2.

13. One or more storage media storing instructions which, when executed by one or more processors, causes performance of the method recited in claim 3.

14. One or more storage media storing instructions which, when executed by one or more processors, causes performance of the method recited in claim 4.

15. One or more storage media storing instructions which, when executed by one or more processors, causes performance of the method recited in claim 5.

16. One or more storage media storing instructions which, when executed by one or more processors, causes performance of the method recited in claim 6.

17. One or more storage media storing instructions which, when executed by one or more processors, causes performance of the method recited in claim 7.

18. One or more storage media storing instructions which, when executed by one or more processors, causes performance of the method recited in claim 8.

19. One or more storage media storing instructions which, when executed by one or more processors, causes performance of the method recited in claim 9.

20. One or more storage media storing instructions which, when executed by one or more processors, causes performance of the method recited in claim 10.
